(19) United States
(12) Patent Application Publication
(10) Pub. No.: US 2009/0048699 A1
(43) Pub. Date: Feb. 19, 2009

(54) System and Method for Detecting a Geometry of a Workpiece

(76) Inventor: Dirk Jahn, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/087,719

(22) PCT Filed: Dec. 6, 2006
(86) PCT No.: PCT/EP2006/069377

§ 371 Date: Jul. 10, 2008

(30) Foreign Application Priority Data
Jan. 11, 2006 (DE) 10 2006 001 496.0

(51) Int. Cl. G05B 19/18; G06F 19/00

(52) U.S. Cl. 700/98; 700/175; 700/173

(57) ABSTRACT

There is described a system and method for detecting a geometry of a workpiece for the purposes of processing the workpiece. In order to simplify optimization of a manufacturing strategy for processing a workpiece, the system has at least one camera for producing at least one image of the workpiece before a processing step, a memory area for desired geometry values the workpiece should have after the processing step, determination means for determining workpiece geometry values the workpiece has before the processing step on the basis of the at least one image, and calculating means for calculating differential geometry values describing a difference between the workpiece geometry values and the desired geometry values.

### CROSS REFERENCE TO RELATED APPLICATIONS

This application is the US National Stage of International Application No. PCT/EP2006/069377, filed Dec. 6, 2006 and claims the benefit thereof. The International Application claims the benefits of German application No. 10 2006 001 496.0 DE filed Jan. 11, 2006, both of the applications are incorporated by reference herein in their entirety.

### FIELD OF INVENTION

The invention relates to a system and method for detecting a geometry of a workpiece for the purposes of machining the workpiece and a machine tool having such a system.

### BACKGROUND OF INVENTION

The invention is deployed for example during the manufacture of a component using a production machine, during which the geometry of the rough part, from which the component is to be manufactured, must be known, in order to determine a suitable manufacturing strategy. The selection of a suitable manufacturing strategy depends not only on the desired geometry, the so-called setpoint geometry, of the component to be produced but also on the volume and geometry of the basic rough part. In particular if the rough parts were produced by means of casting methods, the rough part geometry can fluctuate considerably. The variation in these cast parts means that it is often desirable to develop an adaptive manufacturing strategy as a function of the geometry of the rough part. This requires the geometry of each workpiece or rough part to be known before the machining process.

Knowledge of the rough part geometry in advance of a manufacturing step carried out using a production machine is desirable in particular for cutting machining. Here the difference between the geometry of the basic workpiece and the geometry of the finished component determines the so-called component allowance(s). These component allowances are a measure of the actual volume of the component to be cut during manufacture. For optimal selection of the manufacturing strategy, for example for manufacture with the aid of an NC machine, the NC program and the tool provided for machining should therefore be selected taking into account the component allowances.

The rough part geometry and therefore the allowances for the component to be produced are currently generally determined by means of a mechanical measuring system or in the case of cast parts by way of allowance tables. When a mechanical measuring system is used, the basic workpiece is scanned using a measuring head. To achieve the most accurate determination possible of the rough part geometry, the workpiece must generally be approached a number of times.

### SUMMARY OF INVENTION

An object of the invention is to facilitate the determination of a suitable manufacturing strategy for machining a workpiece.

The object is achieved with the aid of a system for determining geometric changes in a workpiece, which can be produced by a machining step, with the system having:

at least one camera for producing at least one image of the workpiece before the machining step,

a memory region for setpoint geometry values the workpiece should have after the machining step,

determination means for determining workpiece geometry values the workpiece has before the machining step, based on the at least one image and

calculation means for calculating differential geometry values, which describe a difference between the workpiece geometry values and the setpoint geometry values.

The object is also achieved by a method for determining geometric changes in a workpiece, which can be produced by a machining step, with the following method steps:

producing at least one image of the workpiece before the machining step using at least one camera,

determining workpiece geometry values the workpiece has before the machining step, based on the at least one image and

calculating differential geometry values, which describe a difference between the workpiece geometry values and setpoint geometry values the workpiece should have after the machining step.

To optimize a manufacturing step carried out for example with the aid of a machine tool, knowledge of the differential geometry values, which describe the difference between the workpiece geometry before machining and after machining, is an essential input variable. The invention is based on the knowledge that particularly efficient and rapid determination of these differential geometry values can be achieved with the aid of a visual method. To this end the at least one camera is first used to produce an image of the workpiece to be machined. Depending on the machining steps to be carried out on the workpiece, it is of course also possible to produce a number of images of the workpiece. It is generally advantageous to image different perspectives of the workpiece with the camera for this purpose. This can be done for example either by rotating or pivoting the camera or changing the position of the workpiece. The system can of course also have a number of cameras, so that the different perspectives of the workpiece can be images by more than one camera.

The image(s) of the workpiece is/are then used to determine the workpiece geometry values, which characterize the geometry of the workpiece before the machining step.

The geometry of the component to be produced desired after the machining step is stored in the memory region in the form of setpoint geometry values. The difference between the setpoint geometry values and workpiece geometry values is considered as a basis for optimizing the manufacturing strategy. The result of this consideration is characterized by the differential geometry values.

The advantage of the optical system for detecting workpiece geometry described here compared with the methods known from the prior art is that the visual detection of the geometry is considerably faster than scanning the workpiece geometry using a measuring head. With the known mechanical methods, several passes generally have to be carried out to determine the rough part geometry or the workpiece geometry. To avoid collisions with this type of contact-based determination of the rough part geometry, the measuring scanner used can only be brought very slowly up to the workpiece. Therefore such methods as known from the prior art are considerably more time-consuming than the inventive method for detecting workpiece geometry.

Also with the known mechanical methods the position of the workpiece within the machine tool or clamping device must be known at least roughly. Otherwise the measuring scanner must be moved manually to a suitable starting position in order to carry out the measuring process manually. Such manual processes however mean additional time outlay in the machine, taking up productive machine time. If such a manual measuring process takes place within a clamping station, it takes up a significant amount of non-productive time. With the inventive visual system for detecting workpiece geometry it is possible to avoid such increases in productive and/or non-productive time.

The inventive detection of workpiece geometry before the machining step is advantageous in particular for cutting methods. In one advantageous embodiment of the invention therefore the calculation means for calculating the differential geometry values are provided in the form of at least one allowance, which is to be removed from the workpiece in the machining step to achieve the setpoint geometry values. The volume to be cut during machining of the workpiece is a function of the allowance(s) of the component. To minimize tool wear during such a cutting process and/or to keep manufacturing time as short as possible, it is therefore expedient to optimize the manufacturing strategy taking into account the allowance(s). The basic optical determination of workpiece geometry before machining and the resulting determination of the allowance make it possible to reduce the time outlay required for such optimization of the manufacturing strategy considerably compared with the prior art.

The differential geometry values can be used on the one hand as a basis for determining an optimum tool for manufacture. On the other hand the differential geometry values can however also be used, in particular with NC manufacturing processes, to optimize a machining program. Therefore in a further advantageous embodiment of the invention the system has adaptation means to adapt a machining program provided to control the machining of the workpiece as a function of the differential geometry values.

In one advantageous embodiment of the invention the memory region is provided to store a setpoint geometry model corresponding to the setpoint geometry values, said model describing the workpiece after the machining step.

In a further advantageous embodiment of the invention the system has model creation means to create the setpoint geometry model. These model creation means can be used for example to generate the setpoint geometry model based on the machining program. Should there be no setpoint geometry model present as yet in the memory region, in such an embodiment of the invention said model is produced automatically from the machining program and then stored in the memory region.

In a further advantageous embodiment of the invention the determination means for determining the workpiece geometry values are provided in the form of a workpiece geometry model. In an advantageous development of this embodiment the calculation means are provided to calculate the differential geometry values based on the setpoint geometry model and the workpiece geometry model. In this process the corresponding models are used to compare the geometries of the workpiece before and after machining, in order to produce a basis for optimal determination of a manufacturing strategy.

Various image recognition algorithms are available to determine the workpiece geometry values. One advantageous embodiment of the invention is for example characterized in that the determination means are provided to determine the workpiece geometry values by extracting edges of the workpiece from the image.

In a further advantageous embodiment of the invention the system has selection means to select a suitable tool of a machine tool for the machining step based on the differential geometry values. If an allowance is first determined for a cutting method, the allowance and associated volume to be cut can be used to prevent tool fracture in that a correspondingly dimensioned tool of the machine tool is determined on the basis of the differential geometry values or the cut segmentation is adapted correspondingly.

A machine tool with a system according to one of the embodiments described above is advantageous in the field of manufacturing technology for example to optimize machining time, to reduce tool wear, to avoid tool fracture and to ensure the quality of the component to be produced.

### BRIEF DESCRIPTION OF THE DRAWINGS

The invention is described and explained in more detail below with reference to the exemplary embodiments illustrated in the figures, in which:

FIG. 1 shows a schematic diagram of a method for detecting a geometry of a workpiece and

FIG. 2 shows a system for detecting a geometry of a workpiece.

### DETAILED DESCRIPTION OF INVENTION

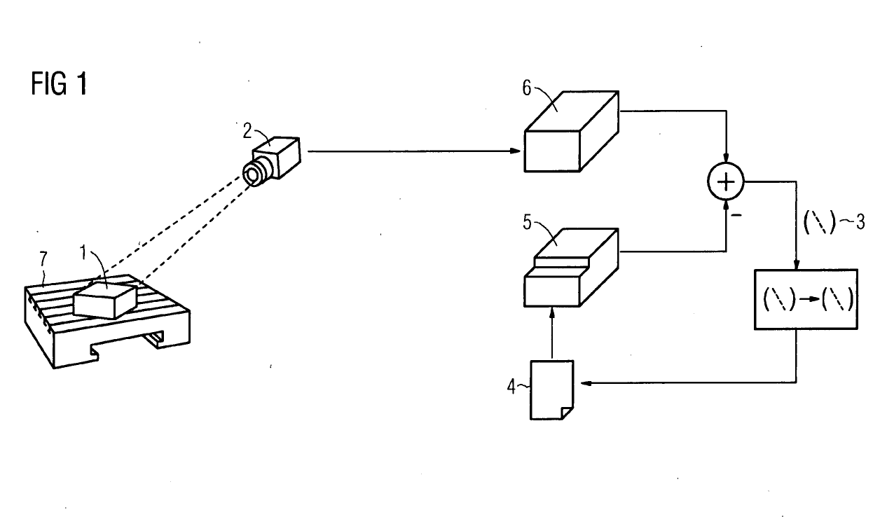

FIG. 1 shows a schematic diagram of a method for detecting a geometry of a workpiece 1. The workpiece 1 is located on a workpiece table 7 of a clamping station. In a cutting machining step a stepped profile is to be milled into the workpiece 1 at one edge of the cuboidal rough part. This milling process is to be carried out using an NC milling machine.

In order to determine an optimal manufacturing strategy for this machining step, the allowance of the milled finished part is to be determined with the shortest possible time outlay with the aid of the illustrated method. The allowance characterizes the volume to be cut with the aid of the milling machine. This volume in turn can be used as a basis for selecting a suitable tool. It is possible to draw conclusions about tool wear during the milling process based on the allowance and thus to select a suitable tool.

The milling process is controlled by a machining program 4, which operates on a numerical controller of the milling machine. To optimize the manufacturing process, in the method shown the NC machining program 4 is adapted as a function of the allowance(s).

To determine the allowances a camera 2 is first used to produce an image of the workpiece 1 to be machined. If the workpiece 7 is supported in a rotatable manner, the workpiece 1 can be moved into different positions, in order to produce further images of the workpiece 1 with the aid of the camera 2.

A mathematical algorithm is used to produce a workpiece geometry model 6 from the images. This is an edge model of the object in question. When this edge model 6 is being created, surrounding objects, such as the workpiece table 7 in the example shown, are first calculated out of the images.

A setpoint geometry model 5 is generated automatically from the machining program 4, describing the dimensions of the workpiece after the milling process. The allowances of the component to be produced are thus obtained by comparing the workpiece geometry model 6 and the set point geometry model 5. Differential geometry values 3, which characterize the allowances of the component, are finally generated by differentiation. The differential geometry values 3 are used on the one hand to select a suitable tool for the milling machine. On the other hand the differential geometry values 3 serve as a basis for adapting the machining program 4 with a view to an optimal manufacturing strategy.

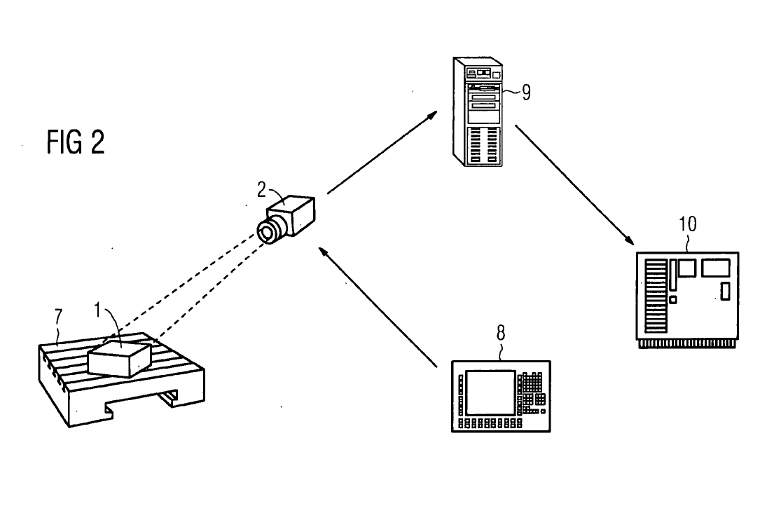

FIG. 2 shows a system for detecting a geometry of a workpiece 1, which is positioned on a workpiece table 7. In order to detect the geometry of this workpiece 1, which serves as a rough part for a manufacturing process, as quickly and efficiently as possible, the system has a camera 2. A user of the system can activate a command to determine the allowance of the part to be manufactured by way of an HMI 8 (Human Machine Interface). After the system has been activated by way of the HMI 8, the camera 2 produces various images of the workpiece 1, with the workpiece table 7 being rotated in each instance between the images, so that new perspectives of the component can be detected by way of the camera 2. The images are sent from the camera 2 to a PC 9. Determination means in the form of a computer program are implemented on the PC 9, being provided to determine workpiece geometry values the workpiece has before the machining step. Calculation means, also in the form of a computer program, are implemented on the PC 9 to calculate differential geometry value, which describe a difference between the workpiece geometry values and the setpoint geometry values. The PC 9 also has a memory region, in which the setpoint geometry values the workpiece should have after the machining step are stored in the form of a setpoint geometry model. The PC 9 also has adaptation means, which can be used to adapt a machining program provided to control the machining of the workpiece 1 as a function of the differential geometry values.

Once a workpiece geometry model has first been generated from the images of the workpiece 1 with the aid of the PC 9, said model has been compared with the setpoint geometry model and the differential geometry values have then been determined, the machining program is adapted automatically on the PC 9 according to the differential geometry values. The machining program thus optimized is then loaded from the PC 9 onto a numerical controller 10 of the machine tool provided for machining.

The described determination of the differential geometry values, which describe the desired change in workpiece geometry during the manufacturing step, is not only advantageous for the separating manufacturing methods described above. The method can be deployed in all manufacturing steps, in which a change in workpiece geometry is to be brought about. Detection of the rough part geometry by means of an optical method can also be expedient for forming methods, e.g. where components are produced from solid rough parts by permanently changing their form, in order to optimize the forming process. Examples of such forming methods are forging, impressing, rolling, extruding, folding, deep-drawing, beading, crimping, straightening and bending. The invention can also be used with coating methods, with which the geometry is changed as masses are added.

1.-19. (canceled)

20. A system for determining geometric changes in a workpiece produced by a machining step, comprising:
a camera for producing at least one image of the workpiece before the machining step;
a memory region for setpoint geometry values the workpiece should have after the machining step;
a determining information for determining workpiece geometry values the workpiece has before the machining step, based on the at least one image; and
a calculation for differential geometry values, which describe a difference between the workpiece geometry values and the setpoint geometry values.

21. The system as claimed in claim 20, wherein for the calculation at least one allowance is provided, which is to be removed in the machining step to achieve the setpoint geometry values of the workpiece.

22. The system as claimed in claim 20, further comprising an adaptation for adapting a machining program provided to control the machining of the workpiece as a function of the differential geometry values.

23. The system as claimed in claim 20, wherein the memory region stores a setpoint geometry model corresponding to the setpoint geometry values, which describes the workpiece after the machining step.

24. The system as claimed in claim 23, wherein the setpoint geometry model is created via the system.

25. The system as claimed in one of claim 23, wherein the determining information is provided to determine the workpiece geometry values in the form of a workpiece geometry model.

26. The system as claimed in claim 25, wherein the differential geometry values are calculated based on the setpoint geometry model and the workpiece geometry model.

27. The system as claimed in claim 20, wherein the workpiece geometry values are determined by extracting edges of the workpiece from the image.

28. The system as claimed in claim 20, wherein a selection is provided to select a tool of a machine tool suitable for the machining step based on the differential geometry values.

29. A machine tool for machining a workpiece, comprising:
a system for determining geometric changes in a workpiece produced by a machining step, having
a camera for producing at least one image of the workpiece before the machining step,
a memory region for setpoint geometry values the workpiece should have after the machining step,
a determining information for determining workpiece geometry values the workpiece has before the machining step, based on the at least one image, and
a calculation for differential geometry values, which describe a difference between the workpiece geometry values and the setpoint geometry values.

30. A method for determining geometric changes in a workpiece, which can be produced by a machining step, comprising:
producing at least one image of the workpiece before the machining step using at least one camera;
determining workpiece geometry values the workpiece has before the machining step, based on the at least one image; and
calculating differential geometry values, which describe a difference between the workpiece geometry values and setpoint geometry values the workpiece should have after the machining step.

31. The method as claimed in claim 30, wherein the differential geometry values are calculated in the form of at least one allowance, which is to be removed from the workpiece in the machining step to achieve the setpoint geometry values.

32. The method as claimed in claim 30, wherein a machining program provided to control the machining of the workpiece is adapted as a function of the differential geometry values.

33. The method as claimed in claim 30, wherein a setpoint geometry model corresponding to the setpoint geometry values, which describes the workpiece after the machining step, is stored in a memory region.

34. The method as claimed in claim 33, further comprising creating the setpoint geometry model.

35. The method as claimed in claim 33, wherein the workpiece geometry values are determined based upon the form of a workpiece geometry model.

36. The method as claimed in claim 35, wherein the differential geometry values are calculated based on the setpoint geometry model and the workpiece geometry model.

37. The method as claimed in one of claim 30, wherein the workpiece geometry values are determined by extracting edges of the workpiece from the image.

38. The method as claimed in one of claim 30, wherein a tool of a machine tool for the machining step is selected based upon the differential geometry values.
